(19) United States
(12) Patent Application Publication
(10) Pub. No.: US 2020/0068813 A1
(43) Pub. Date: Mar. 5, 2020

(54) LIGHT TRANSMISSIVE MATERIAL BASED ON RETAINMENT OF SPECIFIC WAVELENGTHS, AND ITS INSULATION COMPOSITE MATERIAL AND COMPOSITE CARRIER THEREOF

(71) Applicant: CHENG FENG ENTERPRISES CO., LTD., TAINAN CITY (TW)

(72) Inventors: PAO-HUNG IEH, TAINAN CITY (TW); YI-CANG LIN, TAICHUNG CITY (TW)

(21) Appl. No.: 16/197,680

(22) Filed: Nov. 21, 2018

(30) Foreign Application Priority Data
Sep. 3, 2018 (TW) 107130816

(51) Int. Cl. A01G 9/14; G02B 5/20

(52) U.S. Cl. CPC A01G 9/1438; A01G 2009/1461; G02B 5/208

(57) ABSTRACT

The present invention provides a light transmissive material based on retainment of specific wavelengths, and its insulation composite material and composite carrier thereof, wherein, the light transmissive material is used to retain specific wavelengths of light, so that the wavelength of light of a specific section can pass through the light transmissive material. The invention can be applied to the cultivation of plants, letting the specific section of light wavelengths conform to the range of the light wavelengths, which can regulate plant growth, to enhance the photosynthesis effect of plants, and promote plant growth. Also by adding heat insulation materials, to achieve the effect of summer heat insulation and winter heat preservation, which provides a plant-adapted growth environment, thereby improving crop growth efficiency and increasing the yield, which can help solve the problem of human food.

### FIELD OF THE INVENTION

The present invention relates to a light transmissive material based on retainment of specific wavelengths, its insulation composite material and a composite carrier thereof, more particularly to the light transmissive material, insulation composite material, and composite carrier capable of only allowing the light with a wavelength that promotes the growth of a plant to pass through, so as to improve the growth rate of the plant.

### BACKGROUND OF THE INVENTION

Since the 21^{st} century, industrial technologies have been developed and the global population has grown rapidly, and human food supply and demand is one of the urgent issues that demands immediate attention and feasible solutions. With the rapid development of science and technology, the huge amount of fossil fuels consumed by related industries has caused global warming and extreme climate changes in various regions, and thus suppressing the growth of plants and leading to shortage. In addition, the rapid growth of the global population also leads to a serious food problem. In recent years, common greenhouse agriculture, and organic agriculture or farm sheds have been used in order to improve the crop yield and solve the human food problem.

To adjust the environment adaptable for plant growth, a conventional agricultural material mainly composed of a plastic film or a plastic net as disclosed in European Pat. No. 1095964B1 and U.S. Pat. No. 5,138,792 is generally used to build a greenhouse to achieve the effects of shading, pest control, and heat preservation or insulation. However, the plastic film and plastic meet still have the issues of insulation and airtightness.

In addition the growth of plants generally requires sunlight, and the light environment is one of the important necessary factors of the growth and development of the plants. According to the literature of “Photo Morphogenesis in Plant”, blue light with the wavelengths ranging from 400 nm to 520 nm and red light with the wavelengths ranging from 610 nm to 720 nm in sunlight have the greatest impact on plant photosynthesis. When sunlight enters into the atmosphere, the distribution of light energy consists of approximately 5% of ultraviolet light, 45% of visible light and 50% infrared light, wherein some light with a specific wavelength will lead to inhibition of growth, and some light with another specific wavelength will promote the growth of plant. Therefore, a number of researches on the choice of wavelength of light applied for a better growth of plant (such as those disclosed in P.R.C. Pat. No. 1038252, R.O.C. Pat. No. 1463942, and U.S. Pat. Nos. 8,505,237 and 5,953,857) have been conducted in recent years. Covering made of a light transmissive material is select to screen and retain the light of a specific wavelength and eliminate the light with a specific wavelength that is not conducive to the growth of plants, so as to improve the growth efficiency of the plants. However, the ultraviolet light with the wavelengths ranging from 315 nm to 400 nm is capable of inhibiting the growth of stem, avoiding the yellowing of leaves, increasing chlorophyll, promoting the formation of anthocyanin, providing the effect of brightening the plants, and giving lots of benefits to human body. In addition, the ultraviolet light also has the advantages of promoting the synthesis of proteins and organic acids, improving the germination rate of seeds, and increasing the crop yield. However, the aforementioned patents have not taught these, and the shortest wavelength of the light passing through the light transmissive material as disclosed in the aforementioned patents is just 400 nm to 500 nm which still has a limited effect of promoting the growth of plants.

In other conventional methods such as those disclosed in U.S. Pat. No. 20160353672 and P.R.C. Pat. No. 105246322, LED lighting is applied in agricultural planting, wherein the LED lamps act as an adjustable light source and provide the light required for different stage of the plant growth continuously daytime and nighttime to accelerate the plant growth. Although a single LED light source consumes not much electric power, yet the cumulative amount of electric power is still very impressive and leads to the drawbacks of large energy consumption and global warming.

In view of the aforementioned drawbacks, the inventor of the present invention based on years of experience in the related industry to conduct extensive research and experiment on the impact of the wavelength of a light to the growth of plants, and finally developed a feasible solution in accordance with the present invention to overcome the drawbacks of the prior art.

### SUMMARY OF THE INVENTION

The present invention relates to a light transmissive material based on retainment of specific wavelengths, and comprises a light transmissive material including a light transmissive substrate and an insulation material. The insulation material is one selected from the group consisting of antimony tin oxide (ATO), indium tin oxide (ITO), titanium dioxide, silicon dioxide, zinc oxide, and tungsten oxide. The light transmissive material retains a light with a wavelength in a specific section below 750 nm, so that the light can pass the light transmissive substrate. The specific section includes a section A ranging from 320 nm to 380 nm; a section B ranging from 400 nm to 550 nm; a section C ranging from 650 nm to 750 nm; and after a light passes through the light transmissive material, the average transmittance of each specific section being: 5 to 35% for the section A; 30 to 70% for the section B; 15 to 65% for the section C.

Preferably, the light transmissive substrate includes an organic pigment selected from the group consisting of C.I. red PR48:1, C.I. red PR48:2, C.I. red PR48:3, C.I. red PR53-1, C.I. red PR101, C.I. red PR102, C.I. red PR122, C.I. red PR146, C.I. red PR168, C.I. red PR176, C.I. red PR185, C.I. red PR188, C.I. red PR254, C.I. blue PB15:0, C.I. blue PB15:1, C.I. blue PB15:2, C.I. blue PB15:3, C.I. blue PB15:4, C.I. blue PB15:6, C.I. violet PV 19, C.I. violet PV 23, C.I. violet PV 32.

Preferably, a carrier made of a thermoplastic or thermoset polymer, or a bio-degradable plastic.

Preferably, the carrier is made of a thermoplastic or thermoset polymer selected from the group consisting of polyethylene (PE), low density polyethylene (LDPE), linear low density polyethylene (LLDPE), polypropylene (PP), polyvinyl chloride (PVC) or ethylene vinyl acetate (EVA), polymethyl methacrylate (PMMA), polycarbonate (PC), and polyethylene terephthalate (PET).

Preferably, the carrier is a bio-degradable plastic selected from the group of polylactide (PLA), polybutylene succinate (PBS), polybutylene succinate adipate (PBSA), poly butylene adipate-co-terephthalate (PBAT), polyhydroxyalkanoates (PHA), polycaprolactone (PCL), polyvinyl alcohol (PVA), and cellulose nanofiber (CNF).

Preferably, the carrier is mixed with the light transmissive material to form a composite which is a single-layer or multi-layer film, woven net, shelter board, woven fabric or plastic fabric.

Preferably, the organic pigment has a percentage by weight falling within a range from 0.2 to 1%, and the insulation material has a percentage by weight falling within a range from 0.2 to 1%.

Preferably, an additive is selected from the group consisting of a bio-degradable agent, an antioxidant, a light stabilizer, a processing aid, an antistatic agent, a filler, a reinforcement material, and an antifogging agent.

Preferably, the additive has a percentage by weight falling within a range from 0.1 to 1%.

Preferably, the composite carrier is applied for agricultural cultivation and covered between at least a crop and a light source.

Therefore, it is a primary objective of the present invention to provide a light transmissive material that can be applied to the cultivation of plants and can retains a wavelength of light of a specific section by screening the sunlight of a desired wavelength to enhance the photosynthesis effect of plants, and promote plant growth. In addition, heat insulation materials may be added to achieve the effect of reducing the temperature in a high-temperature environment during summer to improve the crop growth efficiency and preserving heat in greenhouses during winter. Further, the present invention provides a composite carrier made of a thermoplastic or thermoset polymer or a bio-degradable plastic, and films, woven nets, shelter boards, woven fabrics or plastic fabrics are manufactured to facilitate the construction of greenhouses, outdoor scaffolding or cover the space for growing plants, so as to promote plant growth and achieve the effects of heat insulation and pest control.

### BRIEF DESCRIPTION OF THE DRAWINGS

FIG. 1 shows a spectrogram of transmittance (T %) versus wavelength (λ) in accordance with a first embodiment of the present invention; and

FIG. 2 shows a spectrogram of transmittance (T %) versus wavelength (λ) in accordance with a second embodiment of the present invention.

### DESCRIPTION OF THE PREFERRED EMBODIMENTS

The term “Retainment of specific wavelengths of light” refers to the penetration of a light with a wavelength in a specific section.

The present invention discloses a light transmissive material based on retainment of specific wavelengths, comprising:

a light transmissive material, including a light transmissive substrate and an insulation material, wherein the insulation material is one selected from the group consisting of antimony tin oxide (ATO), indium tin oxide (ITO), titanium dioxide, silicon dioxide, zinc oxide, and tungsten oxide; and

the light transmissive material is for retaining a light with a wavelength in a specific section below 750 nm, so that the light of the wavelength can pass through the light transmissive substrate; and the specific section includes:

a section A ranging from 320 nm to 380 nm;

a section B ranging from 400 nm to 550 nm; and

a section C ranging from 650 nm to 750 nm;

and it is noteworthy that although the light in the section A, section B and section C can promote plant growth, yet it is still necessary to control their proportion in order to achieve a better growth. After a light passes through the light transmissive material, the specific section of the present invention has the following average transmittance:

5 to 35% for section A;

30 to 70% for the section B; and

15 to 65% for the section C.

The present invention further controls the average transmittance of each section to provide better wavelengths and intensity of the light to improve the plant growth.

The present invention primarily projects a light with full spectrum to the light transmissive material and allows the light with a wavelength in section A, section B and section C to pass through the light transmissive material. Natural sunlight is generally used as the light with full spectrum, since the sunlight has a full spectrum and belongs to a continuous spectrum with Fraunhofer lines. The characteristic dark lines in the sunlight spectrum just has several light beams of a single wavelength, which have a very small impact on plant growth and the impact on plant growth is negligible. Therefore, the sunlight without any additional energy consumption is preferably used as the light source.

In the present invention, the range of retaining the light with wavelengths in section A, section B and section C and the intensity of the passed light are specially designed, since the light with a wavelength in section A can promote the formation of anthocyanin and the synthesis of protein and organic acid. The anthocyanin not just contributes to the brightening effect of the plants only, but also has many beneficial effects to human body and significant effects on increasing crop yield and improving nutrition. As to section B and section C, light is the energy source for plant photosynthesis, and the photoreceptors existing in external environment perceived by the plants include phytochrome and cryptochrome (CRY), and these photoreceptors have a different sensitivity to spectrum (or absorb lights with different wavelength ranges. By using these photoreceptors to receive a light, the spectrum, intensity and illumination of the light are changed, so as to initiate different reactions to complete the, growth and development of the plants, wherein phytochrome mainly senses red light (620˜700 nm) and near infrared light (700˜800 nm), and has the effect of affecting the form of the plants, and cryptochrome is a blue receptor for plants to sense the blue light and near ultraviolet light (330˜390 nm) and its main absorption peaks are 370 nm, 420 nm, 450 nm and 480 nm. The cryptochrome can regulate the plant photosynthesis and thus has a regulation effect on the growth and development of the plants. For example, the growth of the plant stein is controlled at the seedling stage, the seedling is de-yellowed, and the flowering cycle is regulated. The section C belongs to red light and near infrared light which can be absorbed strongly by chlorophyll and shows a stronger effect of photoperiod.

In addition, the light transmissive material can inhibit the light with a wavelength other than those falling in section A, section B and section C below 750 nm, so that the transmittance is approximately 5%, 10%, 15%, 20% or 25%. Further, the transmittance has to be lower than section A to reduce the adverse impact on the plant growth. The wavelength of light above 750 nm may be retained or filtered, since any light with such wavelength has insignificant effect on plant growth. Therefore, the present invention only retains the wavelength of light in section A, section B and section C below 750 nm and controls the intensity of the passing light.

The ratio of the average transmittance of the section B to the average transmittance of section C falls within a range from 1:2 to 9:2, preferably from 1:2 to 3:1. If the portion of blue light is decreased, the plant hormone required for plant growth will be reduced, and thus the plant growth and flowering will be delayed. On the other hand, if the portion of red light is increased, then the absorbance of chlorophyll will be reduced, and thus the photosynthesis and growth rate of the plant will be affected adversely.

In an embodiment, the light transmissive material is an organic pigment or a material containing an organic pigment, wherein the organic pigment is one selected from the group consisting of C.I. red PR48:1, C.I. red PR48:2, C.I. red PR48:3, C.I. red PR53-1, C.I. red PR101, C.I. red PR102, C.I. red PR122, C.I. red PR146, C.I. red PR168, C.I. red PR176, C.I. red PR185, C.I. red PR188, C.I. red PR254, C.I. blue PB15:0, C.I. blue PB15:1 CI blue PB15:2 C.I. blue PB15:3, C.I. blue PB15:4, C.I. blue PB15:6, C.I. violet PV 19, C.I. violet PV 23, C.I. violet PV 32. In the present invention, one or more types of organic pigments may be used to achieve the effect of retaining the wavelength of light and the intensity of the light after the light passes through the light transmissive material. In addition, one or more kinds of organic pigments may be used for preparing the light transmissive material.

In an embodiment, the composite carrier of the light transmissive material is a carrier made of thermoplastic or thermoset polymer, or bio-degradable plastic, wherein if the carrier is made of thermoplastic or thermoset polymer, the polymer is one selected from the group consisting of polyethylene (PE), low density polyethylene (LDPE), linear low density polyethylene (LLDPE), polypropylene (PP), polyvinyl chloride (PVC) or ethylene vinyl acetate (EVA), poly methyl methacrylate (PMMA), polycarbonate (PC), and polyethylene terephthalate (PET), and if the carrier is made of bio-degradable plastic, the bio-degradable plastic is one selected from the group consisting of polylactide (PLA), polybutylene succinate (PBS), polybutylene succinate adipate (PBSA), poly butylene adipate-co-terephthalate (PBAT), polyhydroxyalkanoates (PHA), polycaprolactone (PCL), polyvinyl alcohol (PVA), and cellulose nanofiber (CNF).

In another embodiment, the polymer is a thermoplastic elastomer selected from the group consisting of natural rubber (NR), polybutadiene rubber (BR), styrene butadiene rubber (SBR), nitrile butadiene rubber (NBR), ethylene propylene monomer rubber (EPM), and ethylene propylene diene monomer rubber (EPDM).

In an application, the carrier is mixed with the light transmissive material to form a composite, and the mixing method is a prior art and thus will not be described in details here. The composite may be a single-layer or multi-layer film, woven net, shelter board, woven fabric or plastic fabric disposed between the irradiation position of a light source (such as sunlight) and a surface of space of a plant and covering a plant growing space, a sunlight irradiated surface, a constructed greenhouse, or an outdoor scaffolding to achieve the wind resisting and pest control effects and promote the growth of plants.

With another proportion of the composite, the organic pigment has a percentage by weight falling within a range from 0.2 to 1%, preferably from 0.3 to 0.6%; the insulation material has a percentage by weight falling within a range from 0.2 to 1%, preferably from 0.2 to 0.6%, so that the light transmissive material does not affect the retainment of the light with wavelengths in section A, section B and section C, and the remaining portion is the carrier.

In a preferred embodiment, an insulation material with a particle size below 200 nm (preferably below 100 nm) is used to prepare the light transmissive material of the present invention, so as to improve the transmittance of the light transmissive material.

In another embodiment, an additive may be added if needed, wherein the additive is one selected from the group consisting of a bio-degradable agent an antioxidant, a light stabilizer, a processing aid, an antistatic agent, a filler, a reinforcement material, and an antifogging agent, and the additive has a percentage by weight falling within a range from 0.1 to 1%, preferably from 0.2 to 0.5%, so that the additive does not affect the retainment of the light with a wavelength in section A, section B and section C of the light transmissive material, and the percentages by weight of the organic pigment and the insulation material are the same as described above, so as to provide the corresponding effect to the composite with the additive for this kind.

It is noteworthy that although the wavelength of light falls in section A, section B and section C, yet the light intensity of the sunlight may be too strong or insufficient. A too-strong light intensity may cause the water moisture at the plant surface to evaporate too fast and burn the leaves, and an insufficient light intensity may cause poor absorption and nutrition imbalance. The foregoing preferred ranges of the organic pigment, insulation material and additive are factors of affecting the transmittance of the light transmissive material. Therefore, the specific section and average transmittance of the present invention are maintained.

The present invention is elaborated by the following embodiments, a control group and experiments:

### Embodiment 1

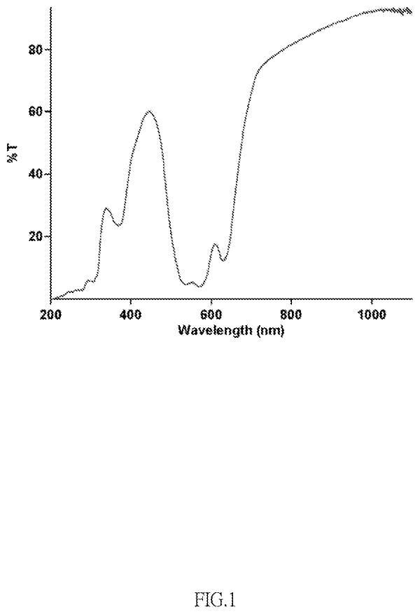

41 g of 3% tungsten oxide and 12.5 g of C.I. violet PV 23 are mixed with 196 g of LDPE (low-density polyethylene), and a single-shaft extruder is provided for kneading at a temperature of 200° C. to 250° C., performing an extrusion by a T-shaped mold, and producing a composite light transmissive film with a thickness of 0.12 mm by using a roller, and the proportion of the gradients by weight of the composite light transmissive film includes 0.5% of tungsten oxide, 0.5% of C.I. violet PV 23, and the remaining is LDPE, and its spectrogram is shown in FIG. 1.

### Embodiment 2

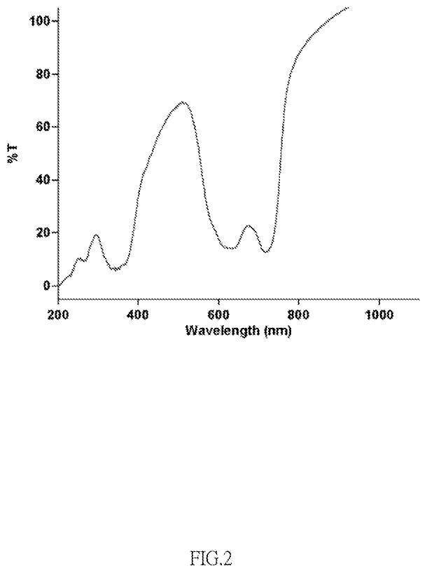

0.83 g of 60% titanium dioxide and 2.5 g of 30% C.I. blue PB15:3 are mixed with 246.67 g of LDPE, and a single-shaft extruder is provided for kneading at a temperature of 200° C. to 250° C., performing an extrusion by a T-shaped mold, and producing a composite light transmissive film with a thickness of 0.11 mm by using a roller, and the proportion of the gradients by weight of the composite light transmissive film includes 0.2% of titanium oxide, 0.3% of C.I. blue PB 15:3, and the remaining is LDPE, and its spectrogram is shown in FIG. 2.

Control Group

250 g of LDPE is prepared, and a single-shaft extruder and a single-shaft extruder is provided for kneading at a temperature of 200° C. to 250° C., performing an extrusion by a T-shaped mold, and producing a composite light transmissive film with a thickness of 0.12 mm by using a roller, and the proportion of the gradients by weight of the composite light transmissive film includes 100% of LDPE.

### EXPERIMENT 1

The composite films prepared from the Embodiment 1, Embodiment 2 and Control Group respectively are used for covering and setting in an environment at a temperature of 31° C. After a far infrared lamp is used for illumination for four hours, the surface temperature of the covered area of the Control Group is 45° C., and the temperature difference between the temperature of the covered area covered by the composite film of Embodiment 1 and Embodiment 2 and the ambient temperature is observed, and the experiment results are listed in Table 1 below:

TABLE 1

| | Embodiment | Embodiment | Control |
|---|---|---|---|
| | 1 | 2 | Group |
| Type of insulation material/ | Tungsten | TiO2 | — |
| Percentage by weight | oxide | 0.2% | |
| | 0.5% | | |
| Type of organic pigment/ | C.I. violet | C.I. blue | — |
| Percentage weight | PV 23 | PB15:3 | |
| | 0.5% | 0.3% | |
| Type of polymer/Percentage by | LDPE | LDPE | LDPE |
| weight | 99% | 99.5% | 100% |
| Thickness (μm) | 120 | 110 | 120 |
| Total Weight (percentage by | 100% | 100% | 100% |
| weight) | | | |
| Section A Average Transmittance | 23.7 | 8.3 | 68 |
| Section B Average Transmittance | 35.1 | 57.1 | 78 |
| Section C Average Transmittance | 59.4 | 19.5 | 84 |
| Ambient temperature after a | 45° C. | 45° C. | 45° C. |
| continual irradiation by a far | | | |
| infrared lamp for four hours | | | |
| Actual measured temperature | 41° C. | 42° C. | 45° C. |
| Environmental temperature | 4° C. | 3° C. | 0° C. |
| difference | | | |

Table 1 shows that after the composite film of the present invention is placed under infrared light, the temperature differences between the surface temperatures of the area covered by the composite films according to Embodiment 1 and Embodiment 2 and the ambient temperature are 4° C. and 3° C. respectively. Compared with the Control Group, the present invention has the thermal insulation effect.

Further, an UV-visible spectrophotometer measurement of the composite films prepared according to Embodiment 1 and Embodiment 2 are conducted by using Agilent's Cary 60 UV-Vis, and the average transmittances (T %) are calculated based on the measurement results and listed in Table I. The measurement results show that the composite carrier of the present invention can retain the light with a wavelength in a specific section (relative to the Control Group).

Experiments on the cultivation of crops (such as leaf vegetables) are conducted according to Embodiment 1 and Control Group respectively to confirm that the present invention has a quick effect of promoting the growth of plants.

### EXPERIMENT 2

Crops including spinach, leaf lettuce and amaranth are used for conducting this experiment, wherein the seedlings of the spinach, leaf lettuce and amaranth are respectively transplanted to 48-liters plastic plates containing a culture, soil, and the composite films prepared according to Embodiment 1 and Control Group are set with a height approximately 30 cm above the plastic plates respectively, and then the plastic plates are placed under a light source (such as sunlight). Under the condition without applying additional fertilizers, the growth results of the spinach, leaf lettuce and amaranth are observed, and the results are listed in Table 2:

TABLE 2

| | Control Group | | Embodiment 1 | |
|---|---|---|---|---|
| | | chlorophyll | | chlorophyll |
| | plant height | content | plant height | content |
| | (cm) | (μg/ml) | (cm) | (μg/ml) |
| spinach | 14 | 7.12 | 24 | 12.79 |
| | (21^{st} day) | | (21^{st} day) | |
| leaf lettuce | 25 | 10.02 | 53 | 15.65 |
| | (25^{th} day) | | (25^{th} day) | |
| amaranth | 31 | 9.66 | 50 | 13.35 |
| | (17^{th} day) | | (17^{th} day) | |

In the testing method and calculation of the chlorophyll content, pest-free leaves of substantially the same leaf color of a complete plant is adopted, and the leaves are washed and cleaned, and the leaf stalk is removed before being put into an oven and baked at a constant temperature of 60° C. for 3 hours to remove the water moisture, and 0.5 g of the dried leaf blade is weighed and added into 100m1 of 95% ethanol, and then put into a bottle. The bottle is sealed with plastic wrap and wrapped by aluminum foil, and the dried leaf blade is extracted in a dark environment at room temperature for 24 hours, and then centrifuged by an extracting liquid in a centrifuge for 10 minutes and then the absorbance at the positions of 665 nm and 645 nm are measured by an UV-Vis spectrophotometer. The total chlorophyll content including the content of chlorophyll a and the content of chlorophyll b is calculated by Formula 1 as shown below:

Chlorophyll a(μg/ml)=13.7A665−5.76A645

Chlorophyll b(μg/ml)=25.8A645−7.60A665 Formula 1

Where, A665 and A645 are the absorbance of the wavelength of light at the positions of 665 nm and 645 nm, and the total chlorophyll content is the sum of the content of the chlorophyll a and the content of the chlorophyll b.

In summation of the description above, the present invention controls, the transmittances of the sections A to C. Compared with the Control Group, the present invention definitely improves the growth of plants and promotes the development of agriculture.

What is claimed is:

1. A light transmissive material based on retainment of specific wavelengths, comprising:
a light transmissive material, including a light transmissive substrate and an insulation material, and the insulation material being one selected from the group consisting of antimony tin oxide (ATO), indium tin oxide (ITO), titanium dioxide, silicon dioxide, zinc oxide, and tungsten oxide;
the light transmissive material retaining alight with a wavelength in a specific section below 750 nm, so that the light can pass the light transmissive substrate; and
the specific section including:
a section A ranging from 320 nm to 380 nm;
a section B ranging from 400 nm to 550 nm; and
a section C ranging from 650 nm to 750 nm;
and after a light passes through the light transmissive material, the average transmittance of each specific section being:
5 to 35% for the section A;
30 to 70% for the section B; and
15 to 65% for the section C.

2. The light transmissive material based on retainment of specific wavelengths according to claim 1, wherein the light transmissive substrate includes an organic pigment selected from the group consisting of C.I. red PR48:1, C.I. red PR48:2, C.I. red PR48:3, C.I. red PR53-1, C.I. red PR101, C.I. red PR102, C.I. red PR122, C.I. red PR146, C.I. red PR168, C.I. red PR176, C.I. red PR185, C.I. red PR188, C.I. red PR254, C.I. blue PB15:0, C.I. blue PB15:1, C.I. blue PB15:2, C.I. blue PB15:3, C.I. blue PB15:4, C.I. blue PB15:6, C.I. violet PV 19, C.I. violet PV 23, C.I. violet PV 32.

3. A composite carrier of the light transmissive material based on retainment of specific wavelengths according to claim 1, comprising a carrier made of a thermoplastic or thermoset polymer, or a bio-degradable plastic.

4. The composite carrier of the light transmissive material based on retainment of specific wavelengths according to claim 3, wherein the carrier is made of a thermoplastic or thermoset polymer selected from the group consisting of polyethylene (PE), low density polyethylene (LDPE), linear low density polyethylene (LLDPE), polypropylene (PP), polyvinyl chloride (PVC) or ethylene vinyl acetate (EVA), polymethyl methacrylate (PMMA), polycarbonate (PC), and polyethylene terephthalate (PET).

5. The light transmissive material based on retainment of specific wavelengths according to claim 3, wherein the carrier is a bio-degradable plastic selected from the group of polylactide (PLA), polybutylene succinate (PBS), polybutylene succinate adipate (PBSA), poly butylene adipate-co-terephthalate (PBAT), polyhydroxyalkanoates (PHA), polycaprolactone (PCL), polyvinyl alcohol (PVA), and cellulose nanofiber (CNF).

6. The composite carrier of the light transmissive material based on retainment of specific wavelengths according to claim 3, wherein the carrier is mixed with the light transmissive material to form a composite which is a single-layer or multi-layer film, woven net, shelter board, woven fabric or plastic fabric.

7. The composite carrier of the light transmissive material based on retainment of specific wavelengths according to claim 3, wherein the organic pigment has a percentage by weight falling within a range from 0.2 to 1%, and the insulation material has a percentage by weight falling within a range from 0.2 to 1%.

8. The composite carrier of the light transmissive material based on retainment of specific wavelengths according to claim 7, further comprising an additive selected from the group consisting of a bio-degradable agent, an antioxidant, a light stabilizer, a processing aid, an antistatic agent, a filler, a reinforcement material, and an antifogging agent.

9. The composite carrier of the light transmissive material based on retainment of specific wavelengths according to claim 8, wherein the additive has a percentage by weight falling within a range from 0.1 to 1%.

10. The composite carrier of the light transmissive material based on retainment of specific wavelengths according to claim 3, wherein the composite carrier is applied for agricultural cultivation and covered between at least a crop and a light source.
